(19) United States
(12) Patent Application Publication
(10) Pub. No.: US 2005/0088316 A1
(43) Pub. Date: Apr. 28, 2005

(54) Well control and monitoring system using high temperature electronics

(75) Inventors: Edgar R. Mallison, Wayzata, MN (US); Thomas G. Stratton, Roseville, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 10/693,357

(22) Filed: Oct. 24, 2003

(51) Int. Cl. G01V 3/00

(52) U.S. Cl. 340/853.1

(57) ABSTRACT

A remote control center controls and monitors a plurality of wells. A surface control and monitoring system is located at each of the wells, and each of the surface control and monitoring systems is in communication with a remote control center. Also, a down hole monitoring and control system is provided within each of the wells, and each of the down hole monitoring and control systems is in communication with at least one of the surface control and monitoring systems. Each of the down hole monitoring and control systems comprises non-cooled, high temperature electronic equipment that can withstand the high temperature environment within the corresponding well.

### TECHNICAL FIELD OF THE INVENTION

The present invention relates to monitoring and/or control systems that are used in high temperature down hole applications.

### BACKGROUND OF THE INVENTION

The control and monitoring of oil and gas wells have become increasingly complex. For example, wells under the control of a single company are being drilled throughout the world. Therefore, the need for central control and monitoring of wells that are widely dispersed geographically is becoming increasingly important. Such central control and monitoring requires the communication of sensor and logging information from the wells to the central controller and the communication of control information from the central controller to the wells.

Moreover, the wells themselves have become increasingly more complex. For example, well holes are being drilled with multiple branches and are being divided into multiple production zones that discretely produce fluid or gas in either common or discrete production tubing. In order to effectively and efficiently control these multiple production zones, it is advantageous to position electronic control and monitoring equipment within the wells so that the zones can be controlled and monitored individually or in groups.

It has been difficult to implement down hole electronic control and monitoring of wells because of the difficult temperature environment within the wells. Unless cooling is provided for the down hole electronic control and monitoring equipment that has been used to control and monitor well production within the well, this equipment has required frequent replacement because of the extreme temperature environment. Frequent replacement of the down hole electronic control and monitoring equipment means a resulting reduction in well production. On the other hand, cooling of the down hole electronic control and monitoring equipment results in higher operating costs. No practical solution to these problems is known today.

The present invention addresses one or more of these problems by using, within the well, high temperature down hole electronic control and monitoring equipment that does not require cooling or frequent replacement.

### SUMMARY OF THE INVENTION

In accordance with one aspect of the present invention, a well control and monitoring system for the control and monitoring of a plurality of wells comprises a remote control center, a plurality of surface control and monitoring systems, and a plurality of down hole monitoring and control systems. Each of the wells is provided with a corresponding one of the surface control and monitoring systems, and the surface control and monitoring systems are in communication with the remote control center. Each of the wells is also provided with at least one of the down hole monitoring and control systems, and each of the down hole monitoring and control systems is in communication with at least one of the surface control and monitoring systems. Moreover, each of the down hole monitoring and control systems comprises a non-cooled, high temperature controller arranged to perform monitoring and control functions within a corresponding one of the wells.

In accordance with another aspect of the present invention, a well control and monitoring system for the control and monitoring of a well comprises a first control and monitoring system located at the well and a second monitoring and control system provided within the well. The first control and monitoring system comprises a controller and a transceiver. The second monitoring and control system comprises a non-cooled, high temperature controller and a non-cooled, high temperature transceiver. The first and second control and monitoring systems communicate with one another through their respective transceivers.

In accordance with still another aspect of the present invention, a down hole monitoring and control system is provided within a well and comprises a non-cooled, high temperature controller and a non-cooled, high temperature transceiver coupled to the non-cooled, high temperature controller. The non-cooled, high temperature transceiver transmits signals into the well and receives signals from the well

### BRIEF DESCRIPTION OF THE DRAWINGS

These and other features and advantages will become more apparent from a detailed consideration of the invention when taken in conjunction with the drawings in which:

FIG. 1 illustrates a monitoring and control system in accordance with one embodiment of the present invention;

FIG. 2 illustrates a representative one of the surface monitoring and control systems shown in FIG. 1; and,

FIG. 3 illustrates a representative one of the down hole monitoring and control systems shown in FIG. 1.

### DETAILED DESCRIPTION

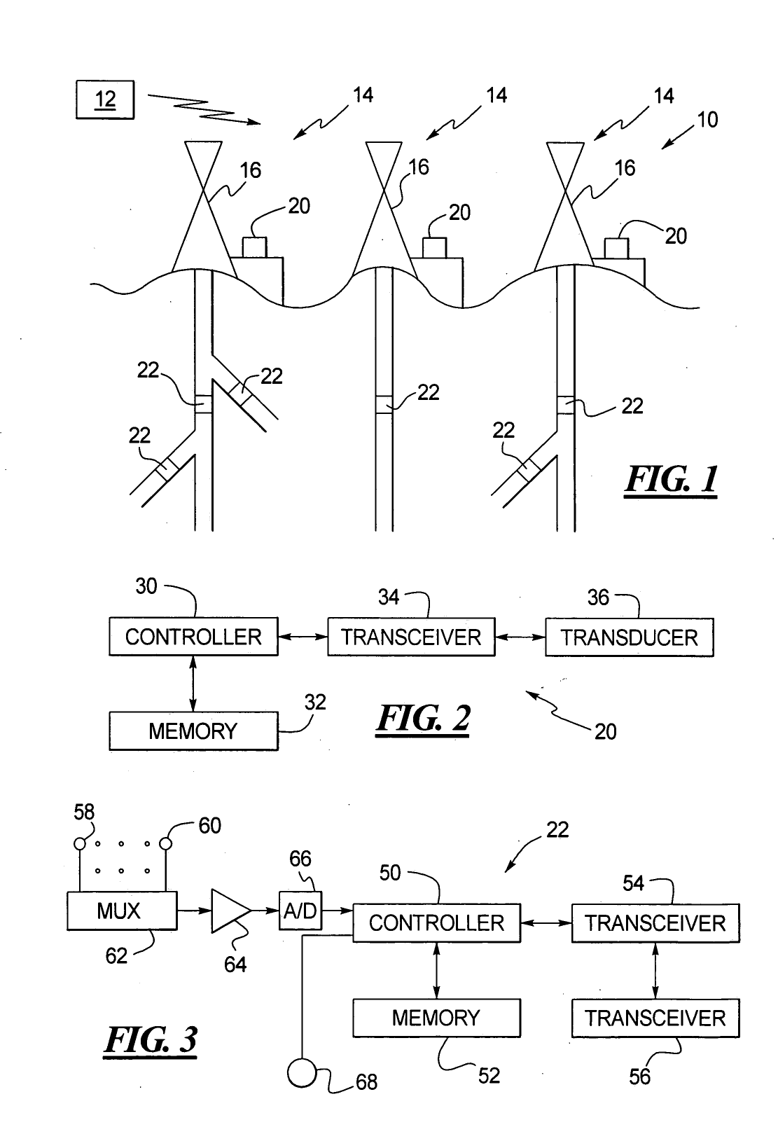

As shown in FIG. 1, a monitoring and control system 10 includes a remote control center 12 that communicates with a plurality of wells 14. Although only three wells are shown in FIG. 1, it should be understood that the monitoring and control system 10 may include any number of wells. Because the wells 14 may be geographically dispersed, the remote-control center 12 remotely communicates with the wells 14 using cellular transmissions, satellite transmissions, telephone lines, and/or the like.

Each of the wells 14 is provided with a corresponding well platform 16 located at the surface of the corresponding one of the wells 14. As shown, the wells 14 extend from the well platforms 16 downwardly into the earth. However, it should be understood that, while the wells 14 are shown over land, one or more of the wells 14 may instead extend down from offshore platforms or from platforms located on other planets.

If desired, each of the wells 14 may be divided into a plurality of separate branches, although each of the wells 14 may instead comprise a single downwardly or laterally directed bore. In addition, it is possible to divide each of the wells 14 into multiple production zones that require separate and/or group monitoring and control for efficient production and management of the well.

A surface monitoring and control system 20 is provided at each of the well platforms 16. Also, a down hole monitoring and control system 22 is provided within each of the wells 14 and, if desired, within each of the production zones of each of the wells 14.

The surface monitoring and control system 20 is arranged to communicate with the down hole monitoring and control systems 22 within its corresponding well. For example, the surface monitoring and control system 20 and the down hole monitoring and control systems 22 associated with a corresponding one of the wells 14 may be arranged to communicate with one another through the use of acoustic signals. However, other types of signals, such as electrical or magnetic signals, may be used to communicate control and monitoring information between the surface monitoring and control systems 20 and the down hole monitoring and control systems 22.

Moreover, the surface monitoring and control system 20 mounted on one of the well platforms 16 may be further arranged to communicate with the down hole monitoring and control systems 22 within one or more of the other wells 14 in order to provide redundant monitoring and control of each of the wells 14 from the surface. For example, the surface monitoring and control system 20 and the down hole monitoring and control systems 22 associated with different ones of the wells 14 may be arranged to communicate with one another through the use of acoustic signals or pulses, although other types of signals may be used.

Likewise, the down hole monitoring and control systems 22 within each of the wells 14 may be arranged to communicate with the down hole monitoring and control systems 22 in one or more of the other wells 14 in order to provide additional redundancy. For example, the down hole monitoring and control systems 22 of different ones of the wells 14 may communicate with one another through the use of acoustic signals, although other types of signals may be used.

Furthermore, the surface monitoring and control systems 20 mounted on the well platforms 16 may be arranged to communicate with the remote control center 12 and with one another. In this case, the surface monitoring and control systems 20 may communicate with the remote control center 12 and with one another using cellular transmissions, satellite transmission, telephone lines, and/or the like.

A representative one of the surface monitoring and control systems 20 is shown in FIG. 2. Accordingly, each of the surface monitoring and control systems 20 includes a controller 30, a memory 32, a transceiver 34, and signal transducers 36. The controller 30 and/or the surface monitoring and control systems 20 may include signal conditioning and/or one or more sensor transducers.

The controller 30, for example, may be a microprocessor programmed to acquire sensor and logging information from the down hole monitoring and control systems 22 within its corresponding well 14. As discussed above, the controller 30 may also be arranged to acquire sensor and logging information (or other attribute that is needed for control and/or monitoring so that higher performance is achieved) from the down hole monitoring and control systems 22 within others of the wells 14. The controller 30 may further be arranged to communicate control information to the down hole monitoring and control system 22 within its corresponding well 14 and to the down hole monitoring and control systems 22 within others of the wells 14. In addition, the controller 30 may be arranged to communicate control information to, and receive sensor and logging information from, the surface monitoring and control systems 20 on other well platforms 16 and the remote control center 12.

The controller 30 controls the transceiver 34 to transmit information to the down hole monitoring and control systems 22 within the wells 14. The controller 30 may employ any addressing scheme to transmit this information to a specific one or group of the down hole monitoring and control systems 22. The controller 30 may also include its own address in the information that it transmits. The signal transducers 36 converts the electrical signals from the transceiver 34 to acoustic signals and directs the acoustic signals through the well and/or earth. These acoustic signals convey information to the desired destination and/or origin of transmission. The signal transducers 36, for example, may be a piezoelectric transducer and may be provided with an anechoic coating. The signal transducers 36 further converts the acoustic signals transmitted by other devices to corresponding electrical signals for processing by the transceiver 34 and the controller 30.

Additional transceivers may be provided to permit the controller 30 to transmit and receive information to and from the surface monitoring and control systems 20 at other well platforms 16 and to and from the remote control center 12.

The memory 32 of the surface monitoring and control system 20 stores the sensor and logging information received from the down hole monitoring and control systems 22 (which can have high temperature memory). The memory 32 also stores the communication programming necessary to communicate with the down hole monitoring and control systems 22, the surface monitoring and control systems 20 on other well platforms 16, and the remote control center 12. The memory 32 further stores the control programming necessary to control the down hole monitoring and control systems 22.

A representative one of the down hole monitoring and control systems 22 is shown in FIG. 3. Thus, each of the down hole monitoring and control systems 22 includes a controller 50, a memory 52, a transceiver 54, and signal transducers 56. The controller 50 and/or the down hole monitoring and control systems 22 may include signal conditioning and/or one or more sensor transducers.

The controller 50 controls the transceiver 54 to transmit information to other down hole monitoring and control systems 22 and to the surface monitoring and control systems 20. The controller 50 may employ any addressing scheme, such as those described above, to transmit information to a specific one or group of destinations. The controller 50 may also include its own address in the information that it transmits.

The signal transducers 56 converts the electrical signals from the transceiver 54 to acoustic signals and directs the acoustic signals through the well. These acoustic signals convey information to the desired destination. The signal transducers 56, for example, may be a piezoelectric transducer and may be provided with an anechoic coating. The signal transducers 56 also converts the acoustic signals transmitted by other devices to corresponding electrical signals for processing by the transceiver 54 and the controller 50.

The controller 50 may be arranged to acquire and log sensor information from a plurality of sensors such as sensors 58 and 60 located in the down hole. The sensors 58 and 60 may be selected to sense any pertinent conditions within the well, such as pressure, temperature, flow, density, and/or other conditions. The sensors 58 and 60 are coupled to a multiplexer 62 that selects the sensors 58 and 60 one at a time for coupling to an amplifier 64. The output of the amplifier 64 is converted to a digital signal by an analog-to-digital converter 66 and the resulting digital signal is then supplied to the controller 50.

As discussed above, the controller 50 may also be arranged to perform control operations within a down hole. Therefore, the controller 50, which may be a smart controller, may also be coupled to one or more electromechanical devices such as an electromechanical device 68. These electromechanical devices may include one or more valves and/or one or more pumps, and/or one or more other devices as may be necessary to implement the desired control functions within the wells 14. The electromechanical device 68 may be a simple on/off device, in which case a digital-to-analog converter is unnecessary. On the other hand, if the electromechanical device 68 is an analog device, a digital-to-analog converter may be provided between the controller 50 and the electromechanical device 68.

The controller 50 may further be arranged to communicate control information to other down hole monitoring and control systems 22 within its corresponding well 14 and to the down hole monitoring and control systems 22 within others of the wells 14. In addition, the controller 50 may be arranged to communicate sensor and logging information to, and receive control information from, the surface monitoring and control systems 20 on its corresponding well platform 16 and on other well platforms 16.

The memory 52 of the down hole monitoring and control systems 22 stores the sensor and logging information. The memory 52 also stores the communication programming necessary to communicate with other down hole monitoring and control systems 22 and with the surface monitoring and control systems 20. The memory 52 further stores the control programming necessary to perform the required control functions.

In order to survive the high temperatures within wells for extended periods of time without cooling, it is necessary for the controller 50, the memory 52, the transceiver 54, the multiplexer 62, the amplifier 64, and the analog-to-digital converter 66 to be high temperature devices. For example, the controller 50 may be a high temperature processor such as a Honeywell HT83C51, the memory 52 may be a high temperature memory such as a Honeywell HT6256, the transceiver 54 may be a high temperature protocol controller such as a Honeywell HT1553P, the multiplexer 62 may be a high temperature monolithic multiplexer such as a Honeywell HT506 or a Honeywell HT507 depending on the number of inputs to be switched, the amplifier 64 may be a monolithic operational amplifier such as a Honeywell HT1104 or a Honeywell HT1104Z, and the analog-to-digital converter 66 may be a high temperature successive approximation A/D converter such as a Honeywell HT574. These devices are specified to operate over a nominal temperature range of −55° C. to +225° C. However, these devices can operate up to 100 years at temperatures as high as 125° C., for 15 to 20 years at temperatures as high as 150° C., for 10 to 15 years at temperatures as high as 175° C., for 5 years at temperatures as high as 225° C., and for a year or more at temperatures as high as 300° C.

The signal transducers 36 and/or 56 may be piezoelectric transducers and/or may be provided with an anechoic coating. As is known, anechoic coatings are coatings that modify the interface between the transmission media and the transducer in order to reduce reflected signals and to enhance the desired acoustic signals. The thickness of the anechoic coating is selected to be a suitable fraction or multiple of the wavelength that is selected for the acoustic signals transmitted through the well and/or earth. For example, the thickness of the anechoic coating may be selected to be ½ of the wavelength of the acoustic signal. Alternatively, the thickness of the anechoic coating may be selected to be a multiple of the wavelength of the acoustic signal. The specific wavelength will depend upon the exact nature of the substances through which the acoustic signal must travel. These substances generally are petrochemicals, water, and earth, but other substances such as various acids and contaminants may also be present.

In any event, the thickness should be chosen so as minimize the effect of acoustic signal impairments, such as echoes, flow and machine noise, and reverberations, on the transducers used to transmit and receive communication signals as described above. Also, it is preferable that the specific material of the anechoic coating provided for the transducers should be selected to withstand the oils, acids, other substances, and high temperatures in the particular well hole that is encountered. Accordingly, the anechoic material may change from hole to hole depending upon the particular mixture of substances found in the specific well hole. Generally, these anechoic materials are some form of rubber or rubber-like material selected for long wear, for adhesion to the transducer interface, and for substantial imperviousness to the substances that are likely to be encountered.

For example, the anechoic coating used with the signal transducers 36 and/or 56 may be an elastomeric or elastomeric polymer, such as silicone, polyurethane, and/or polybutadiene based polymers, bonded to the external surface of the transducers. Particles may be provided in these substances in order to enhance the acoustic signal, and an organic or inorganic cover may be provided. Acoustic energy that arises from acoustic signal impairments, such as echoes, flow and machine noise, and reverberations, and that is incident upon the anechoic coating deform the material of the anechoic coating in order to dissipate this acoustic energy.

Certain modifications of the present invention have been discussed above. Other modifications will occur to those practicing in the art of the present invention. For example, the surface monitoring and control systems 20 and the down hole monitoring and control systems 22 are provided with transceivers in order to transmit and receive signals. However, the surface monitoring and control systems 20 and the down hole monitoring and control systems 22 may be provided with separate transmitters and receivers in order to transmit and receive signals. Alternatively, any of the surface monitoring and control systems 20 and the down hole monitoring and control systems 22 may be provided with only a transmitter or only a receiver if it is desired that the corresponding system only transmit or receive signals. Additionally, the surface monitoring and control systems 20 and the down hole monitoring and control systems 22 may be powered by light, through electrical wires, or by down hole energy sources.

Moreover, in the case where the surface monitoring and control systems 20 and the down hole monitoring and control systems 22 are provided with separate transmitters and receivers, a single transducer may serve both the transmitter and the receiver of a system or separate transducers may be provided for the transmitter and receiver of a system.

Furthermore, although transceivers or separate transmitters and receivers may be used as discussed above, it should be understood that the transceivers or the separate transmitters and receivers may be incorporated into the controllers. In this case, the controllers may be coupled directly to the transducers, or the controllers may be coupled to the transducers through other devices such as D/A converters, and/or multiplexers, and/or the like.

In addition, each of the wells 14 as described above is provided with a corresponding one of the surface monitoring and control systems 20. However, fewer surface monitoring and control systems 20 may be used so that at least one of the surface monitoring and control systems 20 covers more than one of the wells 14.

Also, the signal transducers 36 and 56 emit and receive acoustic signals in order to support communications between the surface monitoring and control systems 20 and the down hole monitoring and control systems 22 and between the down hole monitoring and control systems 22. Instead, the signal transducers 36 and 56 may be arranged to emit and receive other types of signals if acoustic signals are not used to support communications. Moreover, the signal transducers may be turned on and off by signals from their corresponding transceivers.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

1. A well control and monitoring system for the control and monitoring of a plurality of wells comprising:
a remote control center;
a plurality of surface control and monitoring systems, wherein each of the wells is provided with a corresponding one of the surface control and monitoring systems, and wherein the surface control and monitoring systems are in communication with the remote control center; and,
a plurality of down hole monitoring and control systems, wherein each of the wells is provided with at least one of the down hole monitoring and control systems, wherein each of the down hole monitoring and control systems is in communication with at least one of the surface control and monitoring systems, and wherein each of the down hole monitoring and control systems comprises a non-cooled, high temperature controller arranged to perform monitoring and control functions within a corresponding one of the wells.

2. The well control and monitoring system of claim 1 further comprising at least one sensor coupled to the controller of at least one of the down hole monitoring and control systems.

3. The well control and monitoring system of claim 2 further comprising a multiplexer coupling the sensor to the controller of the at least one of the down hole monitoring and control systems, wherein the multiplexer comprises a non-cooled, high temperature multiplexer.

4. The well control and monitoring system of claim 2 further comprising an amplifier coupling the sensor to the controller of the at least one of the down hole monitoring and control systems, wherein the amplifier comprises a non-cooled, high temperature amplifier.

5. The well control and monitoring system of claim 2 further comprising an analog-to-digital converter coupling the sensor to the controller of the at least one of the down hole monitoring and control systems, wherein the analog-to-digital converter comprises a non-cooled, high temperature analog-to-digital converter.

6. The well control and monitoring system of claim 2 further comprising a multiplexer and an amplifier coupling the sensor to the controller of the at least one of the down hole monitoring and control systems, wherein the multiplexer comprises a non-cooled, high temperature multiplexer, and wherein the amplifier comprises a non-cooled, high temperature amplifier.

7. The well control and monitoring system of claim 2 further comprising a multiplexer and an analog-to-digital converter coupling the sensor to the controller of the at least one of the down hole monitoring and control systems, wherein the multiplexer comprises a non-cooled, high temperature multiplexer, and wherein the analog-to-digital converter comprises a non-cooled, high temperature analog-to-digital converter.

8. The well control and monitoring system of claim 2 further comprising an amplifier and an analog-to-digital converter coupling the sensor to the controller of the at least one of the down hole monitoring and control systems, wherein the amplifier comprises a non-cooled, high temperature amplifier, and wherein the analog-to-digital converter comprises a non-cooled, high temperature analog-to-digital converter.

9. The well control and monitoring system of claim 2 further comprising a multiplexer, an amplifier, and an analog-to-digital converter coupling the sensor to the controller of the at least one of the down hole monitoring and control systems, wherein the multiplexer comprises a non-cooled, high temperature multiplexer, wherein the amplifier comprises a non-cooled, high temperature amplifier, and wherein the analog-to-digital converter comprises a non-cooled, high temperature analog-to-digital converter.

10. The well control and monitoring system of claim 1 wherein at least one of the down hole monitoring and control systems comprises a transducer arranged to perform a conversion between an electrical signal and an acoustic signal, and wherein the acoustic signal conveys information through at least one well.

11. The well control and monitoring system of claim 1 wherein at least one of the down hole monitoring and control systems comprises at least one electromechanical device controlled by the controller of the at least one of the down hole monitoring and control systems.

12. The well control and monitoring system of claim 1 wherein at least one of the down hole monitoring and control systems comprises a non-cooled, high temperature multiplexer.

13. The well control and monitoring system of claim 1 wherein at least one of the down hole monitoring and control systems comprises a non-cooled, high temperature amplifier.

14. The well control and monitoring system of claim 1 wherein at least one of the down hole monitoring and control systems comprises a non-cooled, high temperature analog-to-digital converter.

15. The well control and monitoring system of claim 1 wherein at least one of the down hole monitoring and control systems comprises a non-cooled, high temperature multiplexer and a non-cooled, high temperature amplifier.

16. The well control and monitoring system of claim 1 wherein at least one of the down hole monitoring and control systems comprises a non-cooled, high temperature multiplexer and a non-cooled, high temperature analog-to-digital converter.

17. The well control and monitoring system of claim 1 wherein at least one of the down hole monitoring and control systems comprises a non-cooled, high temperature amplifier and a non-cooled, high temperature analog-to-digital converter.

18. The well control and monitoring system of claim 1 wherein at least one of the down hole monitoring and control systems comprises a non-cooled, high temperature multiplexer, a non-cooled, high temperature amplifier, and a non-cooled, high temperature analog-to-digital converter.

19. The well control and monitoring system of claim 1 wherein the non-cooled, high temperature controller comprises a non-cooled, high temperature transceiver.

20. The well control and monitoring system of claim 19 wherein at least one of the down hole monitoring and control systems comprises a non-cooled, high temperature multiplexer.

21. The well control and monitoring system of claim 19 wherein at least one of the down hole monitoring and control systems comprises a non-cooled, high temperature amplifier.

22. The well control and monitoring system of claim 19 wherein at least one of the down hole monitoring and control systems comprises a non-cooled, high temperature analog-to-digital converter.

23. The well control and monitoring system of claim 19 wherein at least one of the down hole monitoring and control systems comprises a non-cooled, high temperature multiplexer and a non-cooled, high temperature amplifier.

24. The well control and monitoring system of claim 19 wherein at least one of the down hole monitoring and control systems comprises a non-cooled, high temperature multiplexer and a non-cooled, high temperature analog-to-digital converter.

25. The well control and monitoring system of claim 19 wherein at least one of the down hole monitoring and control systems comprises a non-cooled, high temperature amplifier and a non-cooled, high temperature analog-to-digital converter.

26. The well control and monitoring system of claim 19 wherein at least one of the down hole monitoring and control systems comprises a non-cooled, high temperature multiplexer, a non-cooled, high temperature amplifier, and a non-cooled, high temperature analog-to-digital converter.

27. A well control and monitoring system for the control and monitoring of a well comprising:
a first control and monitoring system located above the well, wherein the first control and monitoring system comprises a controller and a transceiver; and,
a second monitoring and control system provided within the well, wherein the second monitoring and control system comprises a non-cooled, high temperature controller and a non-cooled, high temperature transceiver, and wherein the first and second control and monitoring systems communicate with one another through their respective transceivers.

28. The well control and monitoring system of claim 27 wherein the second monitoring and control systems comprises at least one sensor coupled to the controller of the second monitoring and control system.

29. The well control and monitoring system of claim 28 further comprising a multiplexer coupling the sensor to the controller of the second monitoring and control system, wherein the multiplexer comprises a non-cooled, high temperature multiplexer.

30. The well control and monitoring system of claim 28 further comprising an amplifier coupling the sensor to the controller of the second monitoring and control system, wherein the amplifier comprises a non-cooled, high temperature amplifier.

31. The well control and monitoring system of claim 28 further comprising an analog-to-digital converter coupling the sensor to the controller of the second monitoring and control system, wherein the analog-to-digital converter comprises a non-cooled, high temperature analog-to-digital converter.

32. The well control and monitoring system of claim 28 further comprising a multiplexer and an amplifier coupling the sensor to the controller of the second monitoring and control system, wherein the multiplexer comprises a non-cooled, high temperature multiplexer, and wherein the amplifier comprises a non-cooled, high temperature amplifier.

33. The well control and monitoring system of claim 28 further comprising a multiplexer and an analog-to-digital converter coupling the sensor to the controller of the second monitoring and control system, wherein the multiplexer comprises a non-cooled, high temperature multiplexer, and wherein the analog-to-digital converter comprises a non-cooled, high temperature analog-to-digital converter.

34. The well control and monitoring system of claim 28 further comprising an amplifier and an analog-to-digital converter coupling the sensor to the controller of the second monitoring and control system, wherein the amplifier comprises a non-cooled, high temperature amplifier, and wherein the analog-to-digital converter comprises a non-cooled, high temperature analog-to-digital converter.

35. The well control and monitoring system of claim 28 further comprising a multiplexer, an amplifier, and an analog-to-digital converter coupling the sensor to the controller of the second monitoring and control system, wherein the multiplexer comprises a non-cooled, high temperature multiplexer, wherein the amplifier comprises a non-cooled, high temperature amplifier, and wherein the analog-to-digital converter comprises a non-cooled, high temperature analog-to-digital converter.

36. The well control and monitoring system of claim 27 wherein the second monitoring and control system comprises a transducer arranged to perform a conversion between an electrical signal and an acoustic signal, and wherein the acoustic signal conveys information through the well.

37. The well control and monitoring system of claim 27 wherein the second monitoring and control system comprises at least one electromechanical device controlled by the controller of the second monitoring and control system.

38. The well control and monitoring system of claim 27 wherein the second monitoring and control system comprises a non-cooled, high temperature multiplexer.

39. The well control and monitoring system of claim 27 wherein the second monitoring and control system comprises a non-cooled, high temperature amplifier.

40. The well control and monitoring system of claim 27 wherein the second monitoring and control system comprises a non-cooled, high temperature analog-to-digital converter.

41. The well control and monitoring system of claim 27 wherein the second monitoring and control system comprises a non-cooled, high temperature multiplexer and a non-cooled, high temperature amplifier.

42. The well control and monitoring system of claim 27 wherein the second monitoring and control system comprises a non-cooled, high temperature multiplexer and a non-cooled, high temperature analog-to-digital converter.

43. The well control and monitoring system of claim 27 wherein the second monitoring and control system comprises a non-cooled, high temperature amplifier and a non-cooled, high temperature analog-to-digital converter.

44. The well control and monitoring system of claim 27 wherein the second monitoring and control system comprises a non-cooled, high temperature multiplexer, a non-cooled, high temperature amplifier, and a non-cooled, high temperature analog-to-digital converter.

45. The well control and monitoring system of claim 27 wherein the first monitoring and control system is located at a surface of the well.

46. A down hole monitoring and control system provided within a well, wherein the down hole monitoring and control system comprises:
a non-cooled, high temperature controller; and,
a non-cooled, high temperature transceiver coupled to the non-cooled, high temperature controller, wherein the non-cooled, high temperature transceiver transmits signals into the well and receives signals from the well.

47. The down hole control and monitoring system of claim 46 further comprising a transducer arranged to perform a conversion between an electrical signal and an acoustic signal, and wherein the acoustic signal conveys information through the well.

48. The down hole control and monitoring system of claim 47 further comprising an anechoic material coating at least a portion of the transducer.

49. The down hole control and monitoring system of claim 46 wherein the non-cooled, high temperature controller comprises a non-cooled, high temperature controller that can be remotely turned on and off.

50. The down hole control and monitoring system of claim 46 wherein the non-cooled, high temperature controller comprises a self-powered non-cooled, high temperature controller.

51. The down hole control and monitoring system of claim 46 wherein the non-cooled, high temperature controller comprises a non-cooled, high temperature controller that is powered remotely by electrical wire.

52. The down hole control and monitoring system of claim 46 wherein the non-cooled, high temperature controller comprises a non-cooled, high temperature controller that is powered remotely by optical cable.

53. The down hole control and monitoring system of claim 46 further comprising at least one electromechanical device controlled by the controller.

54. The down hole control and monitoring system of claim 46 further comprising a non-cooled, high temperature multiplexer.

55. The down hole control and monitoring system of claim 46 further comprising a non-cooled, high temperature amplifier.

56. The down hole control and monitoring system of claim 46 further comprising a non-cooled, high temperature analog-to-digital converter.

57. The down hole control and monitoring system of claim 46 further comprising a non-cooled, high temperature multiplexer and a non-cooled, high temperature amplifier.

58. The down hole control and monitoring system of claim 46 further comprising a non-cooled, high temperature multiplexer and a non-cooled, high temperature analog-to-digital converter.

59. The down hole control and monitoring system of claim 46 further comprising a non-cooled, high temperature amplifier and a non-cooled, high temperature analog-to-digital converter.

60. The down hole control and monitoring system of claim 46 wherein the signals comprises pulses.

61. The down hole control and monitoring system of claim 46 further comprising a non-cooled, high temperature multiplexer, a non-cooled, high temperature amplifier, and a non-cooled, high temperature analog-to-digital converter.
